(19) United States
(12) Patent Application Publication
(10) Pub. No.: US 2026/0225860 A1
(43) Pub. Date: Aug. 6, 2026

(54) METHOD AND DEVICE FOR OPERATING A SLEWING JIB CRANE, AND SLEWING JIB CRANE

(71) Applicant: Wolffkran Holding AG, Cham (CH)

(72) Inventors: Viktor Mosolf, Malsch (DE); Alexey Müller, Schwarzach (DE)

(73) Assignee: Wolffkran Holding AG, Cham, OT (CH)

(21) Appl. No.: 19/150,299

(22) PCT Filed: Jan. 8, 2024
(86) PCT No.: PCT/EP2024/050305

§ 371 Date: Jul. 23, 2025

(30) Foreign Application Priority Data
Jan. 25, 2023 (EP) 23153260.7

(51) Int. Cl. B66C 13/06; B66C 13/46; B66C 13/48; B66C 23/02

(52) U.S. Cl. CPC B66C 13/063; B66C 13/46; B66C 13/48; B66C 23/022

(57) ABSTRACT

A method for operating a slewing jib crane by state control, wherein the state control effects control of a motion of a suspended load at least in one direction of motion and is based on a state vector includes detecting state variables of the state vector, which contain information on position and velocity of a movable suspension point to which a load system comprising a hoist rope, a load-carrying device arranged at a lower end of the hoist rope and a load suspended below the load-carrying device is suspended, and information on load position and load velocity of a center of mass of the load system with respect to the suspension point; determining at least one actuating variable for moving the suspension point in at least one direction of motion based on the state control; and operating the slewing jib crane as a function of at least one actuating variable.

### TECHNICAL FIELD

The invention relates to slewing jib cranes, and in particular to methods for controlling a motion of a suspended load, and in particular to measures for preventing a pendulum oscillation.

### TECHNICAL BACKGROUND

Cranes, and in particular slewing jib cranes or handling cranes, such as tower cranes, mobile cranes and the like, enable the motion of a load by suspending the load from a hoist rope on a jib, lifting the load, moving the load in a substantially horizontal plane and setting the load down. Thus, the motion of the jib is effected by suitable drive devices, and the lifting and setting down of the load is performed by means of a hoisting gear connected to a hoist rope.

In the case of handling cranes, the time required for a transport cycle can be of critical importance for a failure-free operation. During a transport cycle, the unproductive downtime of the crane is to be minimized and the productive operating time of the crane is to be maximized.

For example, in the case of a tower crane, the motion of the load is accomplished by rotating the jib and by moving a trolley along the jib. In the case of mobile cranes, the motion of the load is accomplished by rotating the jib, and, if applicable, by luffing the jib up and down along a horizontal luffing axis. The drive devices as well as the hoisting gear are usually controlled manually by a crane operator by operating suitable operating elements on a crane control unit, wherein the suspended load is deflected with respect to the suspension point on the jib when accelerating and braking, thus triggering a pendulum motion. A pendulum load may pose a potential hazard for both construction workers and construction equipment. In order to prevent such an undesirable pendulum motion of the suspended load, measures for damping the pendulum motion during the operation of the crane are known from the prior art.

For example, document DE 10 2009 032 270 A1 discloses a method for controlling a drive of a mobile crane, wherein a target motion of the jib tip serves as an input variable, on the basis of which a control variable for controlling the drive is calculated. Upon calculation of the control variable, the vibration dynamics of the system consisting of the drive and the crane structure are taken into account in order to reduce natural vibrations.

Document EP 1 628 902 B1 discloses a crane for handling a load suspended from a load rope, including a slewing gear for rotating the crane, a luffing gear for inclining a jib and a hoisting gear for lifting the load suspended from the rope. By means of a path control, a model-based optimal control trajectory is calculated based on a nonlinear model approach, and is updated by feeding back state variables, wherein the output variables of the path control are directly or indirectly incorporated as input variables in a control system for the position or the velocity of the crane. The reference variables for the path control are generated in such a way that a load motion with minimized pendulum deflections is achieved.

Document EP 1 652 810 B1 discloses a method of controlling a crane operating unit for suppressing oscillations of a load suspended from a rope of a crane by performing a control by operating a control device having a filter unit.

In order to prevent the pendulum oscillation, it is known for the application in a crane to perform a predictive control of the crane motion in order to suppress pendulum oscillations. See, for example, J. Smoczek et al., “Robust Predictive Control of an Overhead Crane”, https://doi.org/10.5604/01.3001.0010.2940.

The “Cycoptronic” function is known from the “Liebherr Electronics” brochure of Liebherr Werk Nenzing GmbH dated September 2012, which illustrates a pendulum-free operation of a mobile harbor crane when handling ISO containers between freighters and a port edge area.

Particularly in the case of complex crane structures, conventional pendulum damping devices are inadequate to damp or suppress a pendulum oscillation to a sufficient extent. In particular, the various dynamic effects when lifting, setting down and moving the load due to various deformations of the crane structure cannot be modeled satisfactorily using a physical model, and as a result the pendulum oscillation cannot be sufficiently damped.

Conventional methods are usually based on an assumed approximate load position, which is, for example, determined approximately based on a hoist rope angle with respect to the perpendicular direction, usually at the suspension point of the hoist rope on the jib. However, wind pressure and other dynamic influences may cause transverse oscillations of the hoist rope, such that the measured hoist rope angle does not correspond to the angle of the distance between the suspension point on the jib and the load center of gravity. Additionally, in crane operation, the load to be suspended is suspended from a load-carrying device, such as a hook block, so that the non-negligible weight of the load-carrying device results in a double-pendulum system that often performs a chaotic oscillating motion upon excitation. This is difficult to predict when using conventional physical models, which significantly impairs the quality of pendulum damping based only on the hoist rope angle. Furthermore, the insufficient predictability of the pendulum oscillation of the load may also lead to an intervention of the pendulum damping algorithm, so that the pendulum oscillation is intensified in the worst case.

It is an object of the present invention to provide a method and a device for operating a slewing jib crane, as well as a slewing jib crane and a computer program product for performing the method, which dampens or suppresses a pendulum oscillation in an improved manner and further enables additional operating modes in order to make the transport process of the load safer, faster and easier to perform.

### DISCLOSURE OF THE INVENTION

This object is solved by the method for operating a slewing jib crane by means of a state control according to claim 1, as well as a corresponding device and a slewing jib crane according to the independent claims.

Further embodiments are disclosed in the dependent claims.

According to a first aspect, a method for operating a slewing jib crane by means of a state control is provided, wherein the state control effects a control of a motion of a suspended load at least in one direction of motion and is based on a state vector, comprising the following steps:
detecting state variables of the state vector comprising information on a position and a velocity of a movable suspension point to which a load system comprising a hoist rope, a load-carrying device arranged at a lower end of the hoist rope and a load suspended below the load-carrying device is suspended, and information on a load position and a load velocity of a center of mass of the load system with respect to the suspension point,
determining at least one actuating variable for moving the suspension point in the at least one direction of motion based on the state control;
operating the slewing jib crane as a function of the at least one actuating variable.

As mentioned at the beginning, one of the basic problems when transporting a load using a slewing jib crane is to dampen or suppress the pendulum oscillation of the suspended load to such an extent that a lifting and a setting down as well as the attaching and detaching of the load can be done quickly and safely by construction site workers. It is an object to dampen the pendulum oscillation in each phase of the load transport so that no pendulum oscillation occurs and that the load can be lifted and set down in a shorter period of time.

The load system comprises the suspended load, a load-carrying device, a hoist rope of adjustable length that connects the load-carrying device to the suspension point, and a slinging means with which the suspended load is suspended from the load-carrying device. Due to the mass of the hoist rope and the mass of the load-carrying device at the lower end of the hoist rope, the oscillating load system with the suspended load forms a multiple pendulum system that cannot be modeled in a trivial way, and in general leads to erratic pendulum oscillations when lateral forces are applied. Therefore, it is not easy to determine the actual load position precisely.

The actual load position may indicate a relative position of a center of mass of the entire load system with respect to the suspension point on the jib, and can be provided, for example, as an indication of a lateral load deflection with respect to a perpendicular through the suspension point and/or as an indication of a pendulum angle with respect to a suspension point of the load system with respect to a perpendicular through the suspension point in one or more lateral directions of motion. The load velocity may correspond to the relative velocity of the center of mass of the entire load system with respect to the suspension point.

Common pendulum oscillation damping methods for suppressing the pendulum oscillation estimate the load position, i.e. the load deflection or the pendulum angle, in particular solely on the basis of a hoist rope angle of the hoist rope at the suspension point of the jib and the hoist rope length and the load velocity by determining a derivative of the hoist rope angle, which in reality, however, does not allow a useful determination of the load position and the load velocity for performing a state control. Using such a simplified determination of the load position, especially when using a state controller, leads to inaccurate control behavior and consequently to insufficient suppression of the pendulum oscillation during the operation of the crane.

In this regard, it is advantageous to interpret a control for moving the load to an actual load position or a load position determined in an improved manner, thus eliminating the disruptive effect of the estimation error for the load position.

For this purpose, the load position of the center of mass can be determined as a function of a hoist rope angle, which indicates an angular deviation of the hoist rope attached to the suspension point with respect to the perpendicular through the suspension point, a load rope angle, which indicates an angular deviation of a center of mass with respect to a suspension point on the load-carrying device with respect to the perpendicular, a hoist rope length between the suspension point and a center of mass of the load-carrying device, and a load rope length, i.e. a length of the slinging means, between the suspension point and the center of mass of the load.

A more precise determination of the load position allows the use of a state control for the operation of the slewing jib crane. In this case, the state control is suitable for the implementation of various modes for operating the slewing jib crane. The state control is based on a state vector and supplies, when target specifications are provided, a respective actuating variable for the at least one direction of motion, in particular a respective adjustment velocity of a drive device, such as an adjustment velocity of a trolley travel unit of a tower crane or an adjustment velocity of a luffing angle of a jib of a mobile crane and/or an adjustment velocity of a slewing gear. The state control is cyclically performed in accordance with time-defined control cycles, in particular with control cycle durations of between 10 ms and 500 ms, preferably between 50 ms and 150 ms.

It has been shown that a state control operated on a slewing jib crane control unit is advantageous with a state vector that indicates the position and velocity of the suspension point of the load system for a direction of motion on the one hand, and the load position, i.e. the position of the center of mass of the load system relative to the suspension point (e.g. load deflection, pendulum angle) on the other hand.

The load velocity, i.e. the pendulum angular velocity, is obtained in particular by differentiating the change in the load position with respect to time (load deflection/pendulum angle). The pendulum angle indicates the angle of the actual load deflection, i.e. the deflection of the center of mass, with respect to the suspension point on the jib to the perpendicular through the suspension point in at least one direction of motion, i.e. in a radial x-direction and/or a tangential y-direction.

The direct application of a state control to such a state vector allows to prevent any inaccuracies resulting from elastic deformations and/or caused by lateral influences on the load and the load suspension. The state control can be configured to act separately on the slewing gear for the jib rotation and on the drive device for luffing the jib on, for example, a mobile crane, or on a slewing gear for the jib rotation and on a trolley travel unit for moving a trolley as well as on a hoisting gear on, for example, a tower crane, since the dynamics of the individual motion systems are very different. Therefore, a motion of the load in the radial direction can be controlled by controlling the corresponding drive device for luffing or by controlling the trolley travel unit for moving the trolley according to an actuating variable, while a motion in the tangential direction, i.e. around the rotation axis of the jib, is achieved by controlling the slewing gear for a jib rotation.

Accordingly, the controls can be configured and implemented separately from each other. Thus, various functions including a pendulum damping function can be implemented in different directions of motion, and the corresponding state controllers can be adapted in a suitable way to the different actuating dynamics of the drive devices (slewing gear, trolley travel unit etc.).

By using a state controller, it is possible to precisely specify the trajectories of the actuating variables for controlling the drive devices for moving the suspended load, so that, for example, a pendulum oscillation of the moving load is prevented during the motion of the load.

Suppressing the occurrence of the oscillation of the load in all phases during crane operation allows to suppress a pendulum oscillation at any time during the load transportation process, i.e. a process of attaching the load, lifting the load, moving the load, lowering the load and detaching the load, thus ensuring a faster transportation process, since waiting times due to decaying oscillation processes can be prevented.

The load system forms a multiple pendulum system between the suspension point on the trolley LK and the center of mass of the suspended load, in which further non-negligible masses are present along the load suspension, such as the load-carrying device, which forms a further apex of a pendulum motion. It has been found that the double or multiple pendulum system of the load system consisting of a hoist rope, a load-carrying device, a load rope and a suspended load can be considered as a single pendulum for the implementation of the state control if the load position with respect to the suspension point on the jib is determined in a more precise manner by the sensor fusion method or alternative methods.

In principle, the actual load position can be determined in many ways. For example, a localization system that determines a position vector of a stationary point and a point on the suspended load can be used to determine the load position. For this purpose, localization systems based on a camera system or a transponder system can be used, as is known, for example, from document DE 10 2020 120 699 A1.

Furthermore, a determination of the relative load position by means of a sensor data fusion of a first angle sensor device and a second angle sensor device, which detect and transmit angular data to a control unit, has proven to be effective. The first angle sensor device is arranged at the suspension point of the hoist rope on the jib in order to determine a hoist rope angle in the x- and/or y-direction, i.e. in the radial and/or tangential direction with respect to the jib rotation axis. The hoist rope angle is determined with respect to the perpendicular passing through the suspension point.

Since the hoist rope angle of the hoist rope needs to be determined with respect to the perpendicular, it is preferable to provide for a compensation of the measured jib angle at the suspension point of the hoist rope. In this case, a rotation angle difference with respect to the rotation angle about the jib pivot point due to an elastic bending of the jib can be taken into account, e.g. by using a physical model, which is known per se, or by means of a measurement. Also, the luffing angle (in the vertical direction) and a luffing angle difference (inclination angle) of the jib in the vertical direction due to an elastic bending of the jib can also be taken into account, e.g. by using a physical model, which is known per se, or by means of a measurement.

By means of the second angle sensor device, e.g. on the load-carrying device suspended from the hoist rope, a load rope angle of the suspended load with respect to the perpendicular through a suspension point of the load on the load-carrying device can be determined in the x- and/or y-direction. By fusing the hoist rope angle and the load rope angle (each in the same directions), the relative load position, i.e. the lateral load deflection of the center of mass of the load system to the perpendicular through the suspension point or the pendulum angle of the center of mass of the load system with respect to the perpendicular through the suspension point on the jib may be determined, if the hoist rope length, i.e. the distance between the suspension point on the jib and the center of mass of the load-carrying device, is known and if the length of the slinging means or the load rope with which the load is suspended from the load-carrying device is known or specified. The load position can be determined by applying trigonometric functions which are known per se, or by an approximation based on the relatively small hoist rope angles and load rope angles of <5° each by using a linear function.

The slewing jib crane can then be operated based on the assumed virtual single pendulum system using the state controller without taking into account the elastic deformation of crane structures due to torsional and bending moments, so that it is easier to implement the corresponding state control.

It may be provided that the state control is implemented by updating a parameterization of a state space description in the state space when a state of the crane changes, in particular when a hoist rope length changes, and in particular as a function of a mass of the suspended load and/or a radial position of the suspension point, and by determining a linear combination of the control deviations of the state variables by means of a method of pole specification or a method based on the LQ-method which is used to calculate the at least one actuating variable for the motion of the suspension point.

Thus, a state space representation for a direction of motion in the radial direction (x direction) corresponds to:

$$[ \begin{matrix}{x}^{′} \\ {x}^{″} \\ {φ}_{x}^{′} \\ {φ}_{x}^{″}\end{matrix} ] = {A}_{LK} [ \begin{matrix}x \\ {x}^{′} \\ {φ}_{x} \\ {φ}_{x}^{′}\end{matrix} ] + {b}_{LK} {u}_{LK}$$

An exemplary parameterization of the system matrix A_{LK} and the input vector b_{LK} is as follows:

$$\\ {A}_{LK} = [ \begin{matrix}0 & 1 & 0 & 0 \\ 0 & a 1 & 0 & 0 \\ 0 & 0 & 0 & 1 \\ 0 & a 2 & a 3 & 0\end{matrix} ] \\ {B}_{LK} = [ \begin{matrix}0 \\ b 1 \\ 0 \\ b 2\end{matrix} ]$$

And for example:

$$\\ [ \begin{matrix}{x}^{′} \\ {x}^{″} \\ {φ}_{x}^{′} \\ {φ}_{x}^{″}\end{matrix} ] = [ \begin{matrix}0 & 1 & 0 & 0 \\ 0 & - \frac{1}{T} & 0 & 0 \\ 0 & 0 & 0 & 1 \\ 0 & \frac{1}{lT} & - \frac{g}{l} & 0\end{matrix} ] [ \begin{matrix}x \\ {x}^{′} \\ {φ}_{x} \\ {φ}_{x}^{′}\end{matrix} ] + [ \begin{matrix}0 \\ \frac{c}{T} \\ 0 \\ \frac{c}{lT}\end{matrix} ] {u}_{LK}$$

wherein x corresponds to the radial x-position of the suspension point, φₓ corresponds to the pendulum angle (as a load position) in the radial direction, c corresponds to a predetermined constant, T corresponds to a time constant of a transfer function of the following of the suspension point when controlled by the actuating variable u_{LK} (preferably a velocity), g corresponds to the gravitational constant, and l corresponds to a pendulum length l of the load system. “′” means the first time derivative, and “″” means the second time derivative. Z corresponds to the state vector, A_{LK} corresponds to a system matrix, and b_{LK} corresponds to an input vector. Other parameterizations of the system matrix A_{LK} and the input vector b_{LK} are also possible. The system matrix A_{LK} corresponds to a 4×4 system matrix, and b_{LK} corresponds to a 4-dimensional input vector with state space parameters of the state space representation for the radial motion of the suspension point.

Here, the parameterization of the system matrix A_{LK} and the input vector b_{LK} changes upon each change of the pendulum length l.

By applying a pole specification method or an LQ method, an x-direction-related control vector Kx=[K1, K2, K3, K4]^{T} may result for an updated system matrix A_{LK} for a control equation that is applied to the motion of the suspension point:

$$\\ {u}_{LK}^{*} = ( {x}_{soll} - x ( t ) ) \cdot K 1 + ( {x}_{soll}^{′} - {x}^{′} ( t ) ) \cdot K 2 + ( {φ}_{xsoll} - {φ}_{x} ( t ) ) \cdot K 3 + ( {φ}_{xsoll}^{′} - {φ}_{x}^{′} ( t ) ) \cdot K 4$$

wherein t is the current time step of the control, u*_{LK} is the actuating variable of the control, and x(t), x′(t), φₓ(t), φ′ₓ(t) are the current measured and determined state variables.

The pole specification method and the LQ method are widely known from the prior art, as for example from Holger Lutz, Wolfgang Wendt “Taschenbuch der Regelungstechnik”, Europa-Lehrmittel, 2021, ISBN 9783808558706, and Otto Föllinger, “Regelungstechnik”, Vde Verlag GmbH, 2022, ISBN 9783800755189.

Furthermore, a state space representation for a direction of motion in the tangential direction (y-direction or θ-direction) may correspond to

$$\\ [ \begin{matrix}{θ}^{′} \\ {θ}^{″} \\ {φ}_{y}^{′} \\ {φ}_{y}^{″}\end{matrix} ] = {A}_{DW} [ \begin{matrix}θ \\ {θ}^{′} \\ {φ}_{y} \\ {φ}_{y}^{′}\end{matrix} ] + {b}_{DW} {u}_{DW}$$

An exemplary parameterization of the system matrix A_{DW} and the input vector b_{DW} is as follows:

$$\\ {A}_{DW} = [ \begin{matrix}0 & 1 & 0 & 0 \\ 0 & a 4 & 0 & 0 \\ 0 & 0 & 0 & 1 \\ 0 & a 5 & a 6 & 0\end{matrix} ] \\ {b}_{DW} = [ \begin{matrix}0 \\ b 3 \\ 0 \\ b 4\end{matrix} ]$$

And for example:

$$\\ [ \begin{matrix}{θ}^{′} \\ {θ}^{″} \\ {φ}_{y}^{′} \\ {φ}_{y}^{″}\end{matrix} ] = [ \begin{matrix}0 & 1 & 0 & 0 \\ 0 & \frac{mxg}{{lI}_{A}} & 0 & 0 \\ 0 & 0 & 0 & 1 \\ 0 & ( \frac{{mx}^{2} g}{{lI}_{A}} + \frac{g}{l} ) & - \frac{g}{l} & 0\end{matrix} ] [ \begin{matrix}θ \\ {θ}^{′} \\ {φ}_{y} \\ {φ}_{y}^{′}\end{matrix} ] + [ \begin{matrix}0 \\ \frac{1}{{I}_{A}} \\ 0 \\ \frac{x}{{lI}_{A}}\end{matrix} ] {u}_{DW}$$

wherein θ corresponds to the position of the suspension point, φ_{y} corresponds to the pendulum angle in the tangential direction, I_{A} corresponds to a predetermined, in particular as a function of a mass of the load system, I_{A} corresponds to a moment of inertia acting on the slewing gear, m corresponds to the mass of the load system, and u_{DW} corresponds to an input variable (preferably a velocity) for the slewing gear, i.e. for a drive device for a motion of the suspension point in the tangential direction. A_{DW} corresponds to a 4×4 system matrix, and b_{DW} corresponds to an input vector with state space parameters of the state space representation for the tangential motion of the suspension point. Other parameterizations of the system matrix and of the input vector are also possible.

By applying the pole specification method or the LQ method, a y-direction-related control vector Ky=[K5, K6, K7, K8]^{T} can be obtained for a control equation that is applied to the motion of the suspension point:

$$\\ {u}_{DW}^{*} = ( {θ}_{soll} - θ ( t ) ) \cdot K 5 + ( {θ}_{soll}^{′} - {θ}^{′} ( t ) ) \cdot K 6 + ( {φ}_{ysoll} - {φ}_{y} ( t ) ) \cdot K 7 + ( {φ}_{ysoll}^{′} - {φ}_{y}^{′} ( t ) ) \cdot K 8$$

wherein t is the current time step of the control, u*_{DW} is the actuating variable of the control to be set, and θ(t), θ′(t), φ_{y}(t), φ′_{y}(t) are the current measured and determined state variables.

This also makes it possible to easily adapt the state control to different crane configurations by selecting a manageable number of control parameters. The state control can be based on a state vector Z, which comprises the load position and the load velocity (relative to the suspension point), i.e. a load deflection and a load deflection velocity and/or the pendulum angle and the pendulum angular velocity in one or two lateral directions of motion. The state vector Z can further comprise an indication with respect to the current actuating position and adjustment velocity of the relevant actuating element, i.e. the jib, the trolley and the like, in the relevant x- or y-direction. The current adjustment velocity in the x-direction corresponds to or is a function of, for example, a luffing velocity of the jib in a mobile crane, or a trolley velocity in a tower crane, and in the y-direction of a rotational angular velocity of the jib. Accordingly, the control position corresponds, for example, to the luffing angle or the position of the trolley on the jib for the x-direction and the rotation angle for the y-direction.

It can be provided that the state control is operated in order to implement a pendulum damping function, if in particular a manual or automated crane operation specifies a velocity of the suspension point for at least one of the directions of motion, wherein, for pendulum oscillation damping, a target specification of the information on the load position and the load velocity of the center of mass of the load system of zero in each case is specified, the target specification for the velocity of the suspension point is specified to be zero and the target specification for a position of the suspension point is specified as a position as a function of the specified velocity of the suspension point.

A pendulum damping is achieved with active state control by specifying a load position and a load velocity of φₓₛₒₗₗ, φ_{ysoll}=0, φ′ₓₛₒₗₗ, φ′_{ysoll}, i.e. by specifying a load deflection of 0 and a load deflection velocity of 0 and/or by specifying a pendulum angle of 0 and a pendulum angular velocity of 0. This means that it is the objective of the control to ensure that there is no relative motion of the center of mass of the load system with respect to the suspension point and that the center of mass is exactly perpendicular below the suspension point.

The target specification x′ₛₒₗₗ, θ′ₛₒₗₗ for the velocity of the suspension point of a manually or automatically specified target variable corresponds to zero, while the target specification of the position of the suspension point is determined as a function of the velocity of the suspension point specified by the crane operation. Thus, the target position of the suspension point can result from temporal accumulation of distance increments, each of which corresponds to the product of the target specification of the velocity specified by the crane operation and the control cycle duration to prevent an overshooting when reaching the end position. Thus, for example, when operated by the crane operator, a motion velocity of the luffing of the jib or of the trolley in the x-direction and/or by rotation of the jib in the y-direction can be specified in order to move the load in accordance with the operation request.

The target specification can be input by using a joystick or the like and corresponds to a desired adjustment velocity of a corresponding drive device, in particular in the form of a speed of a motor of the drive device in the form of a slewing gear and/or a trolley travel unit and the like. The target specification of the velocity can indirectly specify the actuating variables for the motion of the suspension point via the control or, corresponding to a mechanical coupling by means of an overdrive transmission or a gear reduction in the transmission in accordance with a specified coupling function (known for the crane configuration), specify the actuating variables for the velocity of the suspension point.

Various operational functions can be implemented by specifying target states. When using the pendulum damping function during ongoing crane operation, the adjustment velocity (x- and/or y-direction) specified by the crane operator is cyclically accumulated to a target specification for the position of the suspension point in the x- or y-direction xₛₒₗₗ, θₛₒₗₗ, as a function of the control cycle duration, while in this case no target specification is assumed for the velocity of the suspension point.

The pendulum damping function is active during crane operation. The crane operation is characterized in that one of the target specifications is unequal to zero, or that an operating element for moving the crane is operated. The pendulum damping function may remain active as long as a predetermined follow-up time has not yet elapsed after the operation of an operating element has been discontinued.

The implementation of the state control allows the implementation of further comfort functions for the operation of the slewing jib crane.

As described above, the control is only performed during active crane operation, and ends at a predetermined follow-up time after the discontinuation of the operation, or after the end of an automatic control of a crane motion. However, it is possible that a residual pendulum oscillation remains after the end of the crane operation and after the deactivation of the state control, for example due to disturbing influences or the like. In this respect, the pendulum damping function can be activated by a crane operator or by another construction site worker who is in corresponding communication with the crane control unit by actively actuating of the first operating element, even when the slewing jib crane is at a standstill, for a predetermined period of time, wherein the target state variable of the load position and the load velocity, i.e. the pendulum angle and the pendulum angular velocity or the load deflection and the load deflection velocity, are set to zero. After operating the first operating element, the state control remains active for a predetermined follow-up time of between 5 s and 20 s, or until the load position and the load velocity indicate no load motion for a certain period of time, e.g. between 1 s and 5 s, or indicate a load motion of less than a predefined threshold value.

Furthermore, after actuating the corresponding first operating element, a peak position of the pendulum oscillation can be determined in a manner which is known per se and can be set as target position. In addition, the follow-up time of the active state control can be set according to the oscillation period duration, wherein the follow-up time can be set according to half of the period duration.

It can be provided that the state control is operated or is operable in order to implement a disturbance variable compensation function, wherein the disturbance variable compensation function is continuously provided with a target specification of the information on the position of the suspension point, which is determined as a function of a stored absolute position of the load, and a target specification of the velocity of the suspension point of zero, and the load position and the load velocity of the center of mass of the load system are not taken into account, in particular by setting the corresponding control deviations of the load position and the load velocity of the center of mass of the load system to zero during the activated disturbance variable compensation function, wherein in particular the target specifications of the information on the position of the suspension point is determined based on the current load position of the center of mass, a pendulum length of the load system and the current position of the suspension point.

Thus, a disturbance variable compensation function can be provided as a further alternative or additional operating function. Thereby, upon activating the disturbance variable compensation function, e.g. by actuating a second operating element, the current absolute position of the load can be specified or stored as the target position.

The current absolute position of the load is thus obtained as an existing position of the suspension point on the jib at the time of activation of the disturbance variable compensation function and the existing load position in the form of a deflection to the perpendicular by addition in one or both lateral directions, wherein the absolute position of the load is calculated by means of the load deflection or the pendulum angle, e.g. by applying trigonometric functions. The control is then performed according to the target specifications for an absolute position of the suspension point, which are cyclically adapted to the respective load position of the center of mass of the load system and the corresponding load velocity. Thus, the load position and the load velocity are not taken into account in the control, in particular by setting the corresponding control deviation or the associated element (factor) of the control vector K to zero during the activated disturbance variable compensation function.

The disturbance variable compensation function can be activated and deactivated manually. The disturbance variable compensation function can switch off automatically if an active crane operation is requested, since the active pendulum damping method is then activated and no stored absolute position of the center of mass of the load system is to be maintained.

It can be provided that the state control is operated or is operable to execute a positioning function, wherein for the state control, as target specifications, the information on the relative position and the relative velocity of the center of mass of the load system of zero is specified, and the position and the velocity of the suspension point are not taken into account, in particular by setting the corresponding control deviations during the activated positioning function or the associated element (factor) of the control vector K to zero.

According to the positioning function, upon operating a suitable third operating element, in particular by a construction site worker who communicates with the control unit of the slewing jib crane via a mobile operating device, a control to the load position and load velocity of the center of mass of the load system can be activated, wherein no control to a position of the suspension point is performed. Thus, only the load position (load deflection or the pendulum angle) or the load velocity (load deflection velocity or the pendulum angular velocity) is controlled to zero in each case. While the third operating element, which is preferably configured as a touch element, is kept active, the load or the load-carrying device can be moved manually. By exerting a lateral force on the load-carrying device or the load, the active positioning function causes the load-carrying device to be displaced laterally, since the active state control attempts to control the load position (load deflection or pendulum angle), which deviates from zero due to the lateral force, back to the target specification of zero. Thus, the corresponding drive devices are being moved in such a way that the compensating motion occurs in the direction of the force exerted on the load-carrying device. After deactivating or releasing the third operating element, the pendulum damping control described above can be activated for a predetermined period of time of between 5 s and 20 s, for example, in order to reduce any remaining oscillations.

It may be provided that the state control is operated or is operable in order to implement a load lifting function when a load is to be lifted, wherein the information on the load position is determined when a lifting force on the hoist rope exceeds a predetermined lifting force threshold value and the load has not yet been lifted, wherein the state control is performed with target specifications for the load position and the load velocity and a velocity of the suspension point of zero, wherein the control deviation with respect to the position of the suspension point is not taken into account, in particular by setting the corresponding control deviations or the associated element (factor) of the control vector K to zero during the activated load lifting function.

In particular, the load lifting function can be activated when lifting the suspended load during the ongoing crane operation. In practice, it usually occurs that the center of mass and the suspension point of the hoist rope are not exactly perpendicular when attaching the load. When the load is lifted, a potentially significant pendulum motion would occur due to the relative position of the center of mass of the load system being other than zero. Therefore, it is intended that the hoist rope be tightened before lifting the load so that it is tensioned. The tensioning of the hoist rope can be detected by monitoring an increase of a force on the hoist rope during a tightening process. The active state control in the state of a load that has not yet been lifted now results in the load position deviating from zero (the deflected pendulum angle or the detected load deflection) being compensated for and the control deviation with respect to the pendulum angle/load deflection becoming zero. Thus, the suspension point on the jib is positioned exactly above the center of mass of the load system, and when this is achieved, the load can be lifted without a pendulum oscillation occurring. In particular, it is provided in this case that the lifting of the load is delayed until the pendulum angle is controlled to zero.

Furthermore, the state control can be operated or can be operable to implement a position approach function in which a stored absolute position of the load is approached and that the load is brought to a standstill there, wherein an absolute position of the load is stored in accordance with a user request, wherein the state control is performed with a target specification for the position of the suspension point, which corresponds to the stored position, a target specification for the velocity of the suspension point of zero, and a target specification for the position and the velocity of the center of mass of zero, as soon as the position of the suspension point during ongoing crane operation has approached the stored position of the suspension point, in particular below a predetermined threshold distance.

According to the position approach function, which is activated by operating a fourth operating element, a specific position can be approached in one or more directions of motion, i.e. in the x- and/or y-direction. Thus, the crane operation is activated, and the load motion is performed in accordance with the crane operation. When the current position approaches the stored position, the load is stopped at the stored position and the function is deactivated subsequently. Thus, after stopping the load at the stored load position, the load can continue to be moved in any direction. As soon as the threshold distance is exceeded again, the position approach function can be reactivated.

The position approach function is based on the state control for the x-direction and/or the y-direction by monitoring the distance of the position of the suspension point with respect to the stored position of the suspension point. If the distance falls below a specified threshold value, the manually or automatically specified target specification for the velocity of the suspension point is set to zero, and the stored load position is set as the target specification. The load position (pendulum angle or the load deflection) and the load velocity (the pendulum angular velocity or the relative load velocity) are then also set to zero. Thus, storing the position of the suspension point sets a limit that cannot be exceeded during ongoing crane operation without first stopping the load at the relevant position or limit. The stored position can be deleted by deactivating the position approach function.

According to a corridor function, a motion trajectory can be specified as a sequence of target load positions along which the motion of the suspended load is controlled or is controllable. For example, the motion trajectory can be specified by means of a tolerance-affected trajectory of load positions, e.g. as a range of absolute load positions in which a motion of the load is permissible. If the load reaches an absolute position of a limit of the specified motion range, the motion of the load is stopped, and the load is guided along the limit of the motion range such that the load moves along a limit range. In this way, prohibited areas can be avoided if there is a prohibited area on the direct travel path between the start position and the target position.

According to a further aspect, a device, in particular a control unit, for operating a slewing jib crane by means of a state control can be provided, wherein the state control effects a control of a motion of a suspended load at least in one direction of motion and is based on a state vector, wherein the device is configured to:
detect state variables of the state vector, which comprises information on a position and a velocity of a movable suspension point to which a load system comprising a hoist rope, a load-carrying device arranged at a lower end of the hoist rope and a load suspended below the load-carrying device is suspended, and information on a load position and a load velocity of a center of mass of the load system with respect to the suspension point,
determine at least one actuating variable for the motion of the suspension point in the at least one direction of motion based on the state control;
controlling the slewing jib crane as a function of the at least one actuating variable.

According to a further aspect, the method according to the invention can be implemented on the slewing jib crane by means of a control unit, wherein a computer program product for executing the method is used in the control unit, by means of which the control unit receives instructions for executing the individual method steps, by means of which the aforementioned advantageous technical effects are achieved in order to enable the previously described functions on the slewing jib crane.

According to a further aspect, a slewing jib crane is provided, comprising one or more drive devices for moving a suspension point for a load system and the above device, wherein the slewing jib crane is controlled by controlling the one or more drive devices.

### BRIEF DESCRIPTION OF THE DRAWINGS

Preferred embodiments are described in more detail below in conjunction with the following figures, wherein:

FIG. 1 is a schematic view of a tower crane;

FIGS. 2 and 3 are views of the load system as a multiple or a single pendulum;

FIG. 4 is a schematic view of the control unit for operating the tower crane of FIG. 1;

FIG. 5 is a flowchart illustrating of a pendulum damping function;

FIG. 6 is a flowchart illustrating a disturbance variable compensation function;

FIG. 7 is a flowchart illustrating a positioning function;

FIG. 8 is a flowchart illustrating a load lifting function;

FIG. 9 is a flowchart illustrating a position approach function.

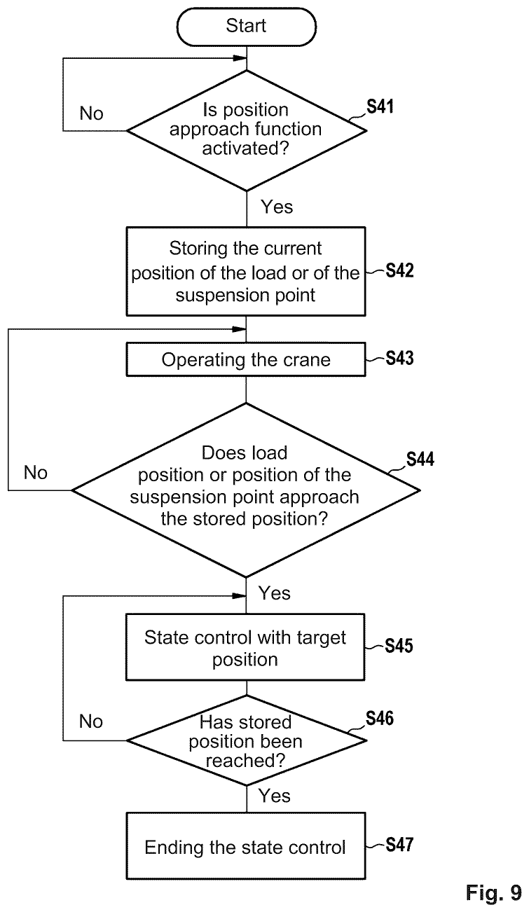

### DESCRIPTION OF EMBODIMENTS

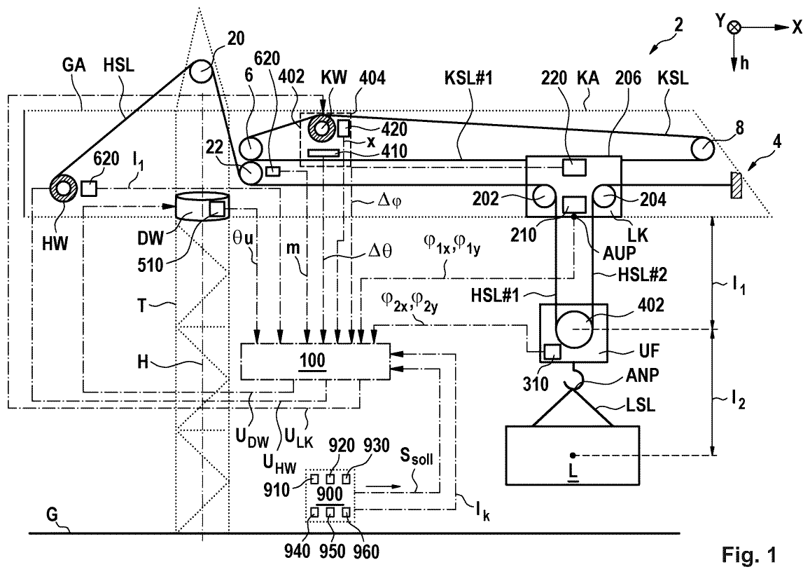

FIG. 1 shows a schematic side view of a tower crane 2 for lifting, moving and setting down a load L. The tower crane 2 represents an example of a slewing jib crane within the meaning of this description. The tower crane 2 comprises a tower T, which is arranged to be fixed at least in part to a base G having an imaginary vertical axis H, and a trolley jib KA projecting from the tower T. The trolley jib KA is not configured to luff, as is shown in FIG. 1. In an example which is not shown, the trolley jib KA can also be configured to luff, wherein the luffing trolley jib KA is moved by means of a luffing drive.

The tower crane 2 comprises a slewing gear DW arranged on the rotating axis for rotating at least the trolley jib KA about the vertical axis H. The tower crane 2 comprises a rotation angle sensor device 510, which is configured for example as a rotation angle sensor for the determination of a rotation angle θ_u of the trolley jib KA about the vertical axis H in an xy plane. The xy plane is generally defined as a tangential y-direction and a radial x-direction.

A trolley LK which is movable along the trolley jib KA comprises a first and a second deflection roller 202, 204 for deflecting a hoist rope HSL in the direction of a load-carrying device UF, which can be configured as a bottom block or a hook block. The load-carrying device UF comprises at least one deflection roller 302 for the hoist rope HSL, but can also comprise a plurality of deflection rollers for the hoist rope HSL.

Starting from a hoisting gear HW, the hoist rope HSL is guided via the first deflection roller 202 of the trolley LK, the one deflection roller 302 of the load-carrying device UF and the second deflection roller 204 of the trolley LK for winding and unwinding the hoist rope HSL. The hoist rope HSL is attached to a distal section 4 of the trolley jib KA.

The hoisting gear HW can comprise, in a manner known per se, a brake, an electric motor, a transmission and a rope winch. The hoist rope HSL is rolled up onto the rope winch of the hoisting gear HW in order to lift the load L, and is rolled off in order to lower the load L. The hoist rope HSL is guided, for example, starting from the hoisting gear via two deflection rollers 20 and 22 arranged at or near the vertical axis H to the deflection roller 202 of the trolley LK.

A hoist rope length l₁ is determined by means of a hoist rope length sensor 610, for example in the form of a rotation angle sensor that counts the rotations of the hoisting gear HW. For example, the distance between the load-carrying device UF and the trolley LK and the suspension point AUP, which is assumed to be the hoist rope length 11, can be determined by detecting the rotational position of the hoisting gear HW.

According to FIG. 1, a mass sensor device 620 is coupled to the deflection roller 22 and detects the mass m of the suspended load L or the load system at a suspension point AUP on the trolley LK, respectively. The mass sensor device 620 measures, for example, a tensile force which is exerted on the deflection roller 22. A sensor signal determined by the sensor device 620 represents the mass m.

A first angle sensor device 210 arranged on the trolley LK is set up for the determination of a respective hoist rope angle φ_{1y}, φ₁ₓ (in the y-direction and in the x-direction) of one or more sections HSL #1, HSL #2 of the hoist rope HSL located between the trolley LK and the load-carrying device UF relative to the perpendicular passing through the suspension point AUP. The first angle sensor device 210 can, for example, include a distance measuring system (optically-based or ultrasound-based) that measures distances, which are a function of the hoist rope angle, between the first angle sensor device 210 and a section of the hoist rope HSL, and derives the hoist rope angle φ_{1y}, φ₁ₓ (in y-direction and in x-direction) therefrom. Other known measurement methods, which are known per se, for the determination of the hoist rope angle φ_{1y}, φ₁ₓ can be applied. The hoist rope angle φ_{1y}, φ₁ₓ (in the y-direction and in the x-direction) corresponds to an angle of the distance between the suspension point AUP and a center of mass of the load-carrying device UF to the perpendicular through the suspension point AUP. The first angle sensor device 210 communicates with a control unit 100 in order to provide it with information on the respective hoist rope angle φ_{1y}, φ₁ₓ.

A second angle sensor device 310 arranged on the load-carrying device UF, for example in the form of a gyroscope, is configured to determine of a load rope angle φ2x, φ2y in the x-direction or the y-direction to the perpendicular passing through the suspension point ANP of the load L to the load-carrying device UF. The load rope angle φ2x, φ2y indicates the angle between the distance between the suspension point ANP and the center of mass of the suspended load and the perpendicular direction through the suspension point ANP in the x-direction or the y-direction. The second angle sensor device 310 is in communication with the control unit.

A load rope length l₂ of the load rope LSL or, in case of another slinging means, a distance between the load-carrying device UF and a center of mass of the load L is specified, for example, or is determinable by a user. Alternatively, this distance can also be determined by using a suitable measuring device.

A trolley travel unit KW, which is arranged to be fixed to the trolley jib KA, is connected by means of a trolley rope KSL to the trolley LK for the motion thereof along the trolley jib KA. The trolley travel unit KW comprises a brake, an electric motor, a transmission and a double rope winch, wherein the double rope winch comprises two sections connected by a common axis, which, upon a rotation of the double rope winch in a rotational direction, rolls up one part of the trolley rope KSL, unrolls the other part, thus moving the trolley LK.

A position sensor device 420, for example a rotation angle sensor which counts the revolutions of the trolley travel unit KW that generates a sensor signal which indicates the position x of the trolley LK is arranged to be fixed to the frame 402. The position x of the trolley LK corresponds to the position of the suspension point AUP.

An angle difference sensor device 410 is set up for the determination of a rotation angle difference Δθ between the rotation angle θ_u of the trolley jib KA about the vertical axis H and a current rotation angle θ of the position of the trolley LK about the vertical axis H. The angle difference sensor device 410 for the determination of the rotation angle difference Δθ is arranged to be fixed to the trolley jib KA, in particular on the trolley jib KA or on a frame 402 of the trolley travel unit KW. The angle difference sensor device 410 can be configured, for example, to determine, e.g. by means of ultrasonic measurement technology, a lateral distance between the angle difference sensor device 410 and a section KSL #1 of the trolley rope KSL, which is located between a proximal fixed deflection roller 6 of the trolley jib KA and the trolley LK. A deflection roller 8 arranged distally to the trolley jib KA deflects the trolley rope KSL from the trolley travel unit KW to the trolley LK. The rotation angle difference Δθ can then be determined either in the angle difference sensor device 410 or in the control unit 100 as a function of the sensor signal representing the distance. Also, other methods known per se for the determination of the rotation angle difference Δθ are applicable. The angle difference sensor device 410 serves to determine the deviation in the rotation angle θ_u of the trolley jib KA from the actual rotation angle θ of the trolley LK or of a suspension point AUP of the load system due to elastic deformation of the trolley jib KA.

The trolley travel unit KW comprises the frame 402 and a drive unit arranged to be fixed to the frame 402 for winding and unwinding a trolley rope KSL. The angle difference sensor device 410, which is arranged to be fixed to the frame 402, is configured to determine the rotation angle difference Δθ between a rotation angle θ_u of the trolley jib KA about a vertical axis H of a tower T of the tower crane 2 and a current rotation angle θ of the trolley LK or of the suspension point AUP about the vertical axis H.

A further inclination sensor device 220, for example in the form of a gyroscope, is fixed to the trolley LK, in particular to the chassis thereof, and serves to determine an inclination angle Δφ (luffing angle difference) of the trolley LK with respect to a horizontal plane. The inclination sensor device 220 determines a sensor signal which characterizes an inclination of the trolley LK to a horizontal plane, in particular an inclination angle lying in an xh plane, which is spanned by the vertical axis h and the longitudinal axis x of the trolley jib KA, to a horizontal plane. For the calculation of the current hoist rope angle φ₁ₓ in the x-direction, the control unit 100 can take into account the inclination angle Δφ as a correction for determining the hoist rope angle φ₁ₓ to the perpendicular through the suspension point AUP. This is necessary because the first angle sensor device 210 usually tilts with the trolley LK, and does not recognize this angular error when measuring the hoist rope angle φ₁ₓ.

The control unit 100 is configured as a conventional data processing device and performs a process to operate the slewing gear DW, the hoisting gear HW and the trolley travel unit KW as a function of all or of a part of the following variables: the rotation angle θ_u, the rotation angle difference Δ0, the hoist rope angle φ₁ₓ, φ_{1y}, the load rope angle φ_{2y}, φ₂ₓ of the hoist rope length l₁, the load rope length l₂, the mass of the suspended load, the position x of the trolley travel unit and the inclination angle Δφ.

For the control of the slewing gear DW, the hoisting gear HW and the trolley travel unit KW, the actuating speeds u*_{DW}, u*_{HW}, u*_{KW} are specified as actuating variables for the motors provided therein. In other embodiments, the control can also be performed by a torque specification.

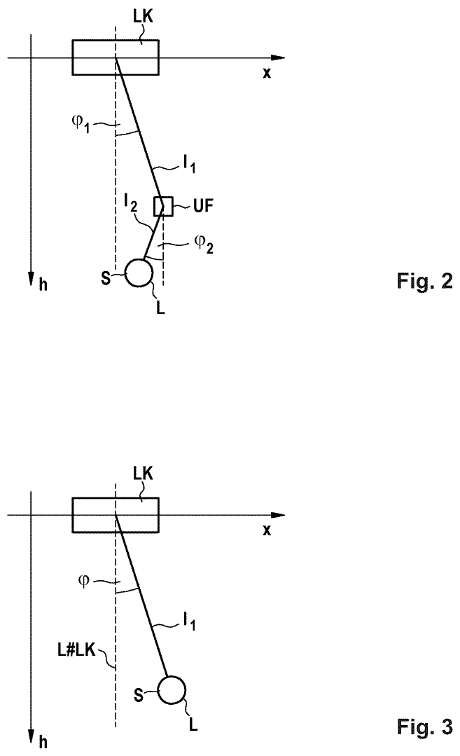

The hoist rope HSL which is suspended from the trolley LK, the load-carrying device UF, the load rope LSL and the load L form a load system. The load system represents a multiple pendulum whose suspension point AUP is assumed to be between two sections HSL #1, HSL #2 of the hoist rope HSL. The multiple pendulum is explained in FIGS. 2 and 3 below and comprises the two sections HSL #1, HSL #2 of the hoist rope HSL, the load-carrying device UF suspended from the hoist rope HSL, a load rope LSL arranged below the load-carrying device UF, and the load L arranged on the load rope LSL. In this context, a multiple or double pendulum, respectively, is understood to be the load system which is located below the trolley LK or below the deflection rollers 202, 204 of the trolley LK.

An operating unit 900 is provided for the operation of the crane. The operating unit 900 is configured, for example, as a control panel in the crane operator's cab and/or as a remote control that is in communication with the control unit 100. For example, a joystick 910 of the operating unit 900 can be used to implicitly transmit target variables Sₛₒₗₗ to the control unit 100, which specify a motion velocity in the x-direction and/or in the y-direction. Furthermore, a lifting or setting down of the load by means of the hoisting gear HW can be specified by the user in the form of a target variable. The target variables comprise u*_{LKsoll}, u*_{DWsoll}, and/or u*_{HWsoll}, and can specify actuating speeds for the motors of the trolley travel unit KW, of the slewing gear DW and/or of the hoisting gear HW, and can be converted into corresponding motions of the suspension point AUP and to a change in the hoist rope length l₁ according to the mechanical specification in a manner known per se, in order to obtain target specifications x′ₛₒₗₗ, θ′ₛₒₗₗ, and/or l′ₛₒₗₗ. The target specifications can also be specified directly as x′ₛₒₗₗ, θ′ₛₒₗₗ, and/or l′ₛₒₗₗ.

FIG. 2 shows a schematic illustration of the double pendulum in the tower crane shown in FIG. 1. In this double pendulum, which is formed by the sections HSL #1, HSL #2 of the hoist rope HSL, the load-carrying device UF, the load rope LSL and the load, there are two relevant angles with respect to one direction, the hoist rope angle φ₁ at the suspension point AUP with respect to the perpendicular through the suspension point AUP and the load rope angle φ₂ at the suspension point ANP with respect to the perpendicular through the suspension point ANP.

FIG. 3 shows the simplification of the multiple pendulum proposed in this description to prevent or reduce a pendulum motion. The multiple pendulum shown in FIG. 2 is considered as a single pendulum for the state control described below. A relevant parameter in this case is the pendulum angle q of the deflection of the load L with respect to the trolley LK. This is difficult to measure directly with robust sensor technology. For one direction, the pendulum angle q is therefore calculated using the hoist rope angle φ₁, the hoist rope length l₁, the load rope length l₂ and the load rope angle φ₂, which are obtained as described above. To compensate the hoist rope angle φ₁ₓ in the x-direction, the angle of inclination Δφ of the trolley jib KA to the horizontal direction can be taken into account, resulting in φ₁ₓ=φ₁+Δφ for the hoist rope angle φ₁ₓ in the x-direction. This correction is not necessary for the hoist rope angle φ_{1y} in the y-direction.

Due to the assumed significantly higher mass of the load L compared to the mass of the load-carrying device UF, the inclination of the load-carrying device UF corresponds to the inclination of the suspended load and thus φ₂, i.e. φ₂ₓ for the x-direction and φ_{2y} for the y-direction.

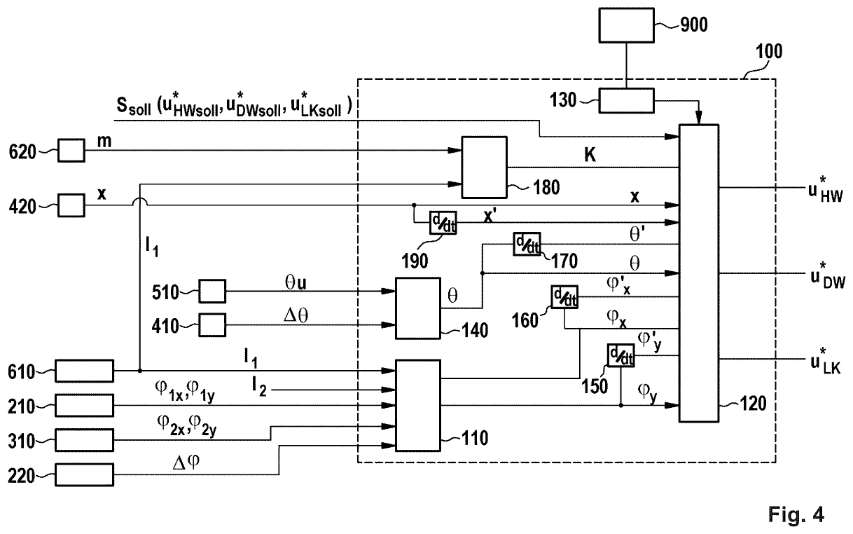

FIG. 4 shows, with reference to FIG. 1, the signal flow for determining actuating variables in the form of control speeds to be set u′_{LK}, u*_{DW}, u*_{HW} for the trolley LK, the slewing gear DW and the hoisting gear HW by the control unit 100. The respective actuating speed can be specified, for example, as a percentage of the maximum speed (rated speed) for the respective drive motor (trolley travel unit KF, slewing gear DW and the hoisting gear HW).

The pendulum angle φₓ, φ_{y} in the x- and y-directions can be calculated in different ways with reference to FIG. 4 in a pendulum angle calculation block 110 in the control unit 100.

An exact calculation gives the length l of the double pendulum as follows:

$$\\ l = \sqrt{{( {l}_{1} cos ( {φ}_{1 x} ) + {l}_{2} cos ( {φ}_{2 x} ) )}^{2} + {( {l}_{1} sin ( {φ}_{1 x} ) + {l}_{2} sin ( {φ}_{2 x} ) )}^{2}}$$

And the pendulum angles φₓ, φ_{y} in the x-direction and the y-direction, respectively, result in:

$$\\ {φ}_{x} = arc sin ( \frac{( {l}_{1} sin ( {φ}_{1 x} ) + {l}_{2} sin ( {φ}_{2 x} ) )}{l} ) \\ {φ}_{y} = arc sin ( \frac{( {l}_{1} sin ( {φ}_{1 y} ) + {l}_{2} sin ( {φ}_{2 y} ) )}{l} )$$

This calculation can be simplified by approximation in the form of a sensor fusion with:

$$\\ l = {l}_{1} + {l}_{2} \\ {φ}_{x} = {k}_{x} {φ}_{1 x} + ( 1 - {k}_{x} ) {φ}_{2 x} \\ {φ}_{y} = {k}_{y} {φ}_{1 y} + ( 1 - {k}_{y} ) {φ}_{2 y}$$

wherein the factors kₓ and k_{y} can be specified as constants, in particular in a range between 0.25 to 0.75, or ca be set according to a characteristic diagram or a function based on the hoist rope length l₁ and/or a mass of the suspended load L, e.g. as

$$\\ {k}_{x} = {k}_{y} = \frac{{l}_{1}}{{l}_{1} + {l}_{2}} .$$

The control unit 100 is supplied with at least the above sensor variables and target variables Sₛₒₗₗ in order to determine the velocity speeds u*_{LK}, u*_{DW}, u*_{HW} in accordance with a state control 120. The target variables may comprise a target speed or a target torque for the trolley travel unit KW, a target speed or a target torque for the slewing gear DW and a target speed or a target torque for the hoisting gear HW.

Furthermore, a function block 130 is provided which controls the operation of the state control 120, in particular as a function of an operation of the operating unit 900, so that various operating functions can be implemented.

In a rotation angle calculation block 140, the rotation angle θ, which is determined by the rotation angle sensor device 510, and the rotation angle difference Δθ, which is measured by the angle difference sensor device 410, are added and a corrected rotation angle θ is provided for an actual rotation angle of the trolley jib KA about the vertical axis H.

By means of suitable derivation blocks 150, 160, 170, 190, the time derivatives for the pendulum angles φₓ, φ_{y}, the corrected rotation angle θ and the velocity x′ of the suspension point AUP can be generated as φ′ₓ, φ′_{y}, θ′ and x′.

Furthermore, the position x of the trolley LK (as the position of the suspension point AUP) is provided by the position sensor device 420 of the state control. By means of the derivation block 190, a trolley velocity x′ (as the velocity of the suspension point AUP) of the state control 120 can be provided as a time derivative. Alternatively, the trolley velocity x′ can be directly read out of the control unit 900, because the trolley velocity is indicated there very precisely at a known (measured) motor speed and a known transmission ratio.

A control parameter block 180 is provided in order to determine, as a function of a mass m of the load system, which is measured by the mass sensor device 620, as a function of a position x of the trolley LK (or the suspension point), which is measured by the position sensor device 420, and as a function of a hoist rope length l₁ or the total pendulum length l of the multiple pendulum, control parameters in the form of a control vector Kx=[K1, K2, K3, K4]^{T}, Ky=[K5, K6, K7, K8]^{T} for the respective direction of motion (the x- and/or the y-direction) from the system matrix A and the input vector b, which are a function of the mass m, the pendulum length l and, if applicable, the position x of the trolley LK (or the suspension point) and are continuously updated. The control parameters K are provided to the state controller 120.

The system matrix A and the input vector b are updated upon a change of at least one of the parameters mass m, the pendulum length l and the position x of the trolley LK (or the suspension point), in particular by more than a predetermined absolute or relative deviation value (of e.g. 2%) in accordance with a determination method for state space parameters, which is known per se. By using the system matrix A and the input vector b, the control parameter block 180 performs a pole specification method, which is known per se, or an LQ-method, which is known per se, in order to determine the respective control vector Kx, Ky based on the state space description.

The state control 120 can be described by means of a state space representation. In the state space representation, linear nth-order systems are broken into n subsystems of the first-order in order to enable the one simple control parameterization. The state controls for the trolley travel unit KW and the slewing gear DW can be considered separately.

In the state control for the trolley travel unit KW, the pendulum angle φₓ in the x-direction, the pendulum angular velocity φ′ₓ thereof, the position x of the trolley and the velocity x′ of the trolley LK are taken into account as state variables.

It is the object of the state control to calculate the actuating variables u*_{LK}, u*_{DW}, u*_{HW} from the state variables of the state variable vector Z and the specified target variables Sₛₒₗₗ=u*_{KWsoll}, u*_{DWsoll}, u*_{HW}, or, if necessary, after the corresponding conversion X′ₛₒₗₗ, O′ₛₒₗₗ, l′ₛₒₗₗ, Thereby, the control deviations of the state variables are multiplied by the respective updated control parameters from the control vectors Kx, Ky. The sum of these products is then the respective actuating variable desired.

The state space representation for the trolley LK is as follows:

$$\\ [ \begin{matrix}{x}^{′} \\ {x}^{″} \\ {φ}_{x}^{′} \\ {φ}_{x}^{″}\end{matrix} ] = {A}_{LK} [ \begin{matrix}x \\ {x}^{′} \\ {φ}_{x} \\ {φ}_{x}^{′}\end{matrix} ] + {b}_{LK} {u}_{LK} ;$$

wherein x″ corresponds to the acceleration of the trolley LK (i.e. of the suspension point AUP), and φ″ₓ corresponds to the angular acceleration of the pendulum angle. A_{LK} corresponds to a 4×4 system matrix, and b_{LK} corresponds to an input vector with state space parameters of the state space description for the trolley travel unit KW. An example of the parameterization of the system matrix A_{LK} and the input vector b may be as follows:

$$\\ {A}_{LK} = [ \begin{matrix}0 & 1 & 0 & 0 \\ 0 & a 1 & 0 & 0 \\ 0 & 0 & 0 & 1 \\ 0 & a 2 & a 3 & 0\end{matrix} ] \\ {b}_{LK} = [ \begin{matrix}0 \\ b 1 \\ 0 \\ b 2\end{matrix} ]$$

wherein a1, a2, a3, b1, b2 are system parameters for the control, which can be determined in a manner known per se, e.g. by physical modeling or empirically. The control vector K can be determined by appropriate application of the pole specification method or the LQ-method, such that the calculation rule for the cyclic calculation of the actuating variable u*_{LK} results as follows:

$$\\ {u}_{LK}^{*} = ( {x}_{soll} - x ( t ) ) \cdot K 1 + ( {x}_{soll}^{′} - {x}^{′} ( t ) ) \cdot K 2 + ( {φ}_{xsoll} - {φ}_{x} ( t ) ) \cdot K 3 + ( {φ}_{xsoll}^{′} - {φ}_{x}^{′} ( t ) ) \cdot K 4$$

In normal operation with active pendulum damping, the desired velocity u*_{LKsoll} of the trolley (i.e. of the suspension point AUP) is specified by the operating unit 900, in particular a joystick or the like, in the range from −100 to 100% of a specified nominal velocity. This is converted into the velocity x′ of the trolley or the suspension point AUP according to the mechanical coupling to the trolley or rather the suspension point AUP.

In the state control for the slewing gear DW, the pendulum angle φ_{y} in the y-direction, the pendulum angular velocity φ′_{y} thereof, the rotation angle θ of the trolley jib and the rotational angular velocity θ′ of the trolley jib are taken into account as state variables.

The state space representation for the slewing gear DW is as follows:

$$\\ [ \begin{matrix}{θ}^{′} \\ {θ}^{″} \\ {φ}_{y}^{′} \\ {φ}_{y}^{″}\end{matrix} ] = {A}_{DW} [ \begin{matrix}θ \\ {θ}^{′} \\ {φ}_{y} \\ {φ}_{y}^{′}\end{matrix} ] + {b}_{DW} {u}_{DW}$$

wherein θ″ corresponds to the rotation angle acceleration and φ″_{y} corresponds to the angular acceleration of the pendulum angle in the y-direction. A_{DW} corresponds to a 4×4 system matrix, and b_{DW} corresponds to an input vector with state space parameters of the state space description for the slewing gear DW. An exemplary parameterization of the system matrix A_{DW} and the input vector b_{DW} is as follows:

$${A}_{DW} = [ \begin{matrix}0 & 1 & 0 & 0 \\ 0 & a 4 & 0 & 0 \\ 0 & 0 & 0 & 1 \\ 0 & a 5 & a 6 & 0\end{matrix} ]$$

$${b}_{DW} = [ \begin{matrix}0 \\ b 3 \\ 0 \\ b 4\end{matrix} ]$$

wherein a4, a5, a6, b3, b4 are control parameters for the control, which can be determined in a manner known per se, e.g. by physical modeling or empirically. The control vector Ky=[K5, K6, K7, K8]^{T} may be determined by appropriately applying the pole specification method or the LQ method, so that the calculation rule for the cyclic calculation of the actuating variable u*_{DW} is obtained:

$${u}_{DW}^{*} = ( {θ}_{soll} - θ ( t ) ) \cdot K 5 + ( {θ}_{soll}^{′} - {θ}^{′} ( t ) ) \cdot K 6 + ( {φ}_{ysoll} - {φ}_{y} ( t ) ) \cdot K 7 + ( {φ}_{ysoll}^{′} - {φ}_{y}^{′} ( t ) ) \cdot K 8$$

In normal operation with an active pendulum damping, the desired rotational velocity u*_{DWsoll} of the slewing gear is specified by the operating unit 900, in particular a joystick or the like, in the range from −100 to 100% of a specified nominal velocity. This nominal velocity is converted into the rotational angular velocity θ′ of the trolley jib or an angular velocity θ′ of the suspension point AUP according to the mechanical coupling to the trolley or the suspension point AUP.

The state controller can also comprise the hoisting gear HW as well, and can comprise the total pendulum length l and the pendulum length velocity l′ as state variables. Accordingly, the control model may have the following structure:

$$[ \begin{matrix}{x}^{′} \\ {x}^{″} \\ {φ}_{x}^{′} \\ {φ}_{x}^{″} \\ {θ}^{′} \\ {θ}^{″} \\ {φ}_{y}^{′} \\ {φ}_{y}^{″} \\ {l}^{′} \\ {l}^{″}\end{matrix} ] = [ \begin{matrix} & & & & & & & & 0 & 0 \\ & & & & & & & & 0 & 0 \\ & {A}_{LK} & & & {A}_{DW} & \to & {A}_{LK} & & 0 & 0 \\ & & & & & & & & 0 & 0 \\ 0 & 0 & 0 & 0 & & & & & 0 & 0 \\ 0 & 0 & 0 & 0 & & & & & 0 & 0 \\ 0 & 0 & 0 & 0 & & {A}_{DW} & & & 0 & 0 \\ 0 & 0 & 0 & 0 & & & & & 0 & 0 \\ 0 & 0 & 0 & 0 & 0 & 0 & 0 & 0 & & \\ 0 & 0 & 0 & 0 & 0 & 0 & 0 & 0 & {A}_{HW} & \end{matrix} ] [ \begin{matrix}x \\ {x}^{′} \\ {φ}_{x} \\ {φ}_{x}^{′} \\ θ \\ {θ}^{′} \\ {φ}_{y} \\ {φ}_{y}^{′} \\ l \\ {l}^{′}\end{matrix} ] + [ \begin{matrix} & 0 & 0 \\ {b}_{LK} & 0 & 0 \\ & 0 & 0 \\ & 0 & 0 \\ 0 & & 0 \\ 0 & & 0 \\ 0 & {b}_{DW} & 0 \\ 0 & & 0 \\ 0 & 0 & \\ 0 & 0 & {b}_{HW}\end{matrix} ] [ \begin{matrix}{u}_{LK} \\ {u}_{DW} \\ {u}_{HW}\end{matrix} ]$$

The state control uses the target variables u*_{DWsoll}, u*_{LKsoll} and u*_{HWsoll} as target specifications. The corresponding target specifications for the control then correspond to the converted θ′ₛₒₗₗ, x′ₛₒₗₗ and l′ₛₒₗₗ, which result from the conversion of the speeds of the drive devices DW, LW, HW corresponding to the target variables u*_{DWsoll}, u*_{LKsoll} and u*_{HWsoll} (target specifications) into the corresponding motion velocities of the slewing gear and the trolley travel unit KW in lateral directions (x, y) and of the load in the vertical direction (h).

The control may follow a control cycle duration of between 10 ms and 500 ms. The control system may have an observer that calculates the state variables in advance for the next time step. Observer structures are known from the state of the art and are not explained in more detail herein.

In contrast to a conventional control system, an optimal trajectory of the actuating variables u*_{LK}, u*_{DW}, u′_{HW} (upon neutralization of an occurrence of oscillation leading to a pendulum motion) of the load is calculated on the basis of the available state variables so that no strong pendulum motion caused by the crane operator or the crane operation can occur. Subsequent damping of the oscillating pendulum system is therefore not necessary. After activating the state control to perform a pendulum damping function using a corresponding target specification Sₛₒₗₗ after the load has been lifted, the target variables are converted into the corresponding target specifications θ′ₛₑₜ, x′ₛₑₜ and l′ₛₑₜ according to the respective mechanical coupling between the trolley travel unit KW, the slewing gear DW and the hoisting gear HW to the trolley LK, the trolley jib KA and the load-carrying device UF and taken into account in the control:

For the x-direction:

$${u}_{LK}^{*} = ( {x}_{soll} - x ( t ) ) \cdot K 1 + ( {x}_{soll}^{′} - {x}^{′} ( t ) ) \cdot K 2 + ( {φ}_{xsoll} - {φ}_{x} ( t ) ) \cdot K 3 + ( {φ}_{xsoll}^{′} - {φ}_{x}^{′} ( t ) ) \cdot K 4$$

For the y-direction:

$${u}_{DW}^{*} = ( {θ}_{soll} - θ ( t ) ) \cdot K 5 + ( {θ}_{soll}^{′} - {θ}^{′} ( t ) ) \cdot K 6 + ( {φ}_{ysoll} - {φ}_{y} ( t ) ) \cdot K 7 + ( {φ}_{ysoll}^{′} - {φ}_{y}^{′} ( t ) ) \cdot K 8$$

wherein t is the current time step of the control, and x(t), x′(t), φₓ(t), φ′ₓ(t), θ(t), θ′(t), φ_{y}(t), φ′_{y}(t) are the current measured and determined state variables.

The following applies to the pendulum damping function during crane operation:

$${x}_{soll} = f ( {u}_{LKsoll} )$$

$${x}_{soll}^{′} = 0$$

$${φ}_{soll} = 0$$

$${φ}_{xsoll}^{′} = 0$$

$${θ}_{soll} = f ( {u}_{DWsoll} )$$

$${θ}_{soll}^{′} = 0$$

$${φ}_{ysoll} = 0$$

$${φ}_{ysoll}^{′} = 0$$

The functions for determining the target position of the suspension point correspond to:

$${x}_{soll}^{} ( t ) = f ( {u}_{LKsoll}^{*} ) = {x}_{soll} ( t - 1 ) + {x}_{soll}^{′} ( t - 1 ) * Δ t$$

$${θ}_{soll}^{} ( t ) = g ( {u}_{DWsoll}^{*} ) == {θ}_{soll} ( t - 1 ) + {θ}_{soll}^{′} ( t - 1 ) * Δ t$$

wherein Δt is the control cycle duration of e.g. between 10 ms and 100 ms. Furthermore, the functions f( ) and g( ) can also take ramp functions for the velocity into account in order to limit the rates of change of the specified variables.

The entire control system can be described by the above state controller. The state controller is active at all times during the operation of the tower crane and remains active for a specified follow-up time after the end of an operating specification in order to prevent any subsequent oscillation.

Alternatively, the control may also be applied to only one or two of the motion components, i.e. the motion of the trolley (i.e. x-motion of the suspension point AUP) (x-direction), the rotational motion of the trolley jib (i.e. y-motion of the suspension point AUP) (y-direction) or the motion of the hoisting gear (h-direction). Accordingly, the considered states of the state control 120 are reduced by the respective parameters.

For using the pendulum damping function which is achieved by the state control, further additional functions for operating the tower crane can be implemented.

For this purpose, for example, a first operating element 920 can be provided on the operating unit 900, with which the user can damp existing load or residual pendulum oscillations according to a pendulum damping function, which occur after a load transport operation. This pendulum damping function corresponds to the conventional pendulum damping function described above, which is activated when the first operating element 920, which can be configured as a pushbutton switch, for example, is operated and remains active during a follow-up time of, for example, between 5 s and 30 s, preferably between 5 s and 15 s, in particular of 10 s, after the end of the operation of the first operating element 920. The follow-up time can be predefined or depend on a current pendulum length l. Thus, the respective follow-up time can be variably predefined by a function or a look-up table based on the pendulum length l.

By providing the function of the first operating element 920, the crane operator of the tower crane has the option of reducing a pendulum oscillation occurring due to a brief sudden application of force to the load system, for example, when the crane operation is inactive, i.e. there is no active transport motion.

Furthermore, when the first operating element 920 is actuated, a target position of the load can first be determined, which is used as an additional target specification for the control. Usually, the position of the load L corresponds to the position x of the trolley (i.e. the suspension point AUP) and the current rotation angle θ of the jib. These data are then stored as target specifications xₛₜₒᵣₑ, θₛₜₒᵣₑ and used for pendulum damping in addition to the target specifications θ′ₛₒₗₗ₌₀, x′ₛₒₗₗ₌₀ and l′ₛₒₗₗ₌₀ (no control for crane operation), and the state control is performed accordingly. The following then applies to the target specifications in the above regulation rule:

$${x}_{soll} = {x}_{store}$$

$${x}_{soll}^{′} = 0$$

$${φ}_{xsoll} = 0$$

$${φ}_{xsoll}^{′} = 0$$

$${θ}_{soll} = {θ}_{store}$$

$${θ}_{soll}^{′} = 0$$

$${φ}_{ysoll} = 0$$

$${φ}_{ysoll}^{′} = 0$$

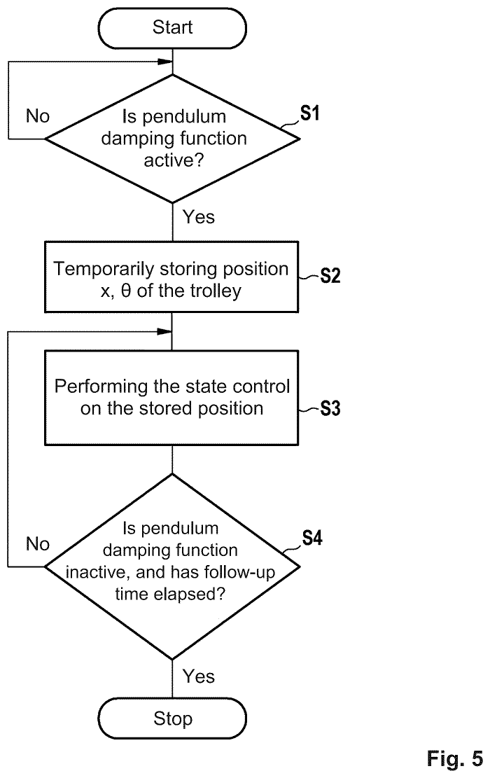

FIG. 5 shows a corresponding flowchart to illustrate this pendulum damping function.

In step S1, it is checked whether the pendulum damping function is activated when the crane is inactive. If this is the case (alternative: Yes), the process continues with step S2. Otherwise (alternative: No), the process is continued with S1.

In step S2, the position x, θ of the trolley LK (i.e. the suspension point AUP) is temporarily stored as xₛₜₒᵣₑ, θₛₜₒᵣₑ and is assumed as the target variable for the subsequent control.

In step S3, the state control is performed, wherein the target specifications xₛₒₗₗ=xₛₜₒᵣₑ, θₛₒₗₗ=θₛₜₒᵣₑ, lₛₒₗₗ are assumed in addition to the target specifications θ′ₛₒₗₗ=0, x′ₛₒₗₗ=0 und l′ₛₒₗₗ=0 for pendulum damping and the state control is performed accordingly.

In step S4, it is checked whether the pendulum damping function has ended and a follow-up time has elapsed. If this is the case (alternative: Yes), the process is ended, otherwise (alternative: No), the program returns to step S3 and the state control is continued.

By means of a function extension, which can be activated or deactivated by a second operating element 930, a disturbance variable compensation function can be provided. The disturbance variable compensation function can, for example, take into account external influences on the load system, such as wind pressure or vibrations of the ground, and maintain the current position of the load L despite the presence of (persistent) disturbances. If the function is activated by operating the second operating element 930, it remains active until it is ended by operating the second operating element 930 accordingly. The disturbance variable compensation function continues to be active only as long as the crane is not actively operated, i.e. the load is not moved by external target specifications.

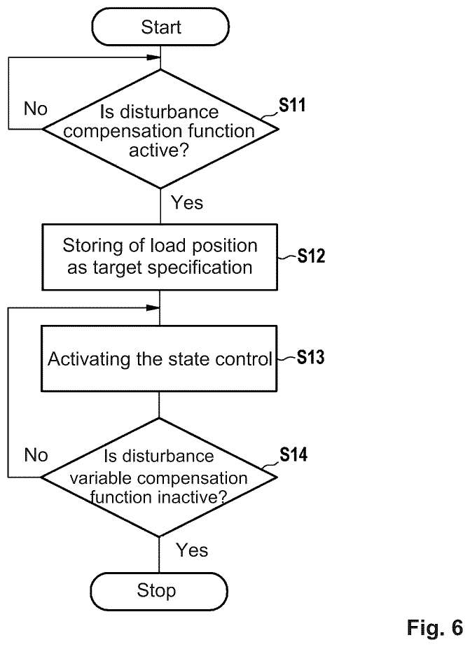

FIG. 6 illustrates a flowchart illustrating the disturbance variable compensation function.

In step S11, it is checked whether the disturbance variable compensation function is activated when the crane is inactive. If this is the case (alternative: Yes), the process continues with step S12. Otherwise (alternative: No), the process continues with S11.

In step S12, the current absolute load position pₓₛₒₗₗ, p_{ysoll}, is stored as the target specification. The current absolute load position pₓₛₒₗₗ, p_{ysoll} to be stored can be determined as:

$${p}_{xsoll} = x + sin ( {φ}_{x} ) \cdot l$$

$${p}_{ysoll} = θ + arctan \frac{sin ( {φ}_{y} ) \cdot l}{x}$$

In step S13, the state control is activated, wherein the state control is provided with varying target specifications for the position xₛₒₗₗ of the trolley and the rotation angle θₛₒₗₗ in accordance with the control cycles. The pendulum length lₛₒₗₗ remains unchanged.

The following then applies to maintaining the absolute position pₓₛₒₗₗ, p_{ysoll} of the load:

$${x}_{soll} = {p}_{xsoll} - sin ( {φ}_{x} ) \cdot l$$

$${θ}_{soll} = {p}_{ysoll} - arctan \frac{sin ( {φ}_{y} ) \cdot l}{x}$$

These values are continuously determined, i.e. recalculated for each control cycle, as the pendulum angles φₓ, φ_{y} and the pendulum angular velocities φ′ₓ, φ′_{y} can change constantly as the disturbance influence varies.

The target specifications for the state variables during the active disturbance variable compensation function are then:

$${x}_{soll} = {p}_{xsoll} - sin ( {φ}_{x} ) \cdot l$$

$${x}_{soll}^{′} = 0$$

$${φ}_{xsoll} = undefined$$

$${φ}_{xsoll}^{′} = undefined$$

$${θ}_{soll} = {p}_{ysoll} - arctan \frac{sin ( {φ}_{y} ) \cdot l}{x}$$

$${θ}_{soll}^{′} = 0$$

$${φ}_{ysoll} = undefined$$

$${φ}_{ysoll}^{′} = undefined$$

wherein xₛₒₗₗ, θₛₒₗₗ are continuously updated according to the control cycles as described above. Thus, it is possible to react appropriately to changing disturbances, and the absolute position of the load remains unchanged.

The state variables φₓ, φ′_{y}, φ_{y}, φ′_{y} marked as undefined are not taken into account in the control by setting the corresponding control deviation or the associated element (factor) of the control vector K to zero during the activated disturbance variable compensation function.

In step S14 it is checked whether the disturbance variable compensation function has ended. If this is the case (alternative: Yes), the process is ended, otherwise (alternative: No) the system returns to step S13, and the state control is continued. The disturbance variable compensation function may be deactivated by operating the second operating element 930 accordingly or by joystick operation to initiate a load transport.

By the actuation of a third operating element 940 (e.g. in the form of a pushbutton switch), a positioning function can be activated. The positioning function remains active as long as the third operating element 940 is operated and is active during a predetermined follow-up time, for example between 5 s and 30 s, preferably between 5 s and 15 s, for example 10 s. The positioning function is configured to move the load by manually pushing and pulling it in the set-down area and thus directing it with high precision to the correct desired load position.

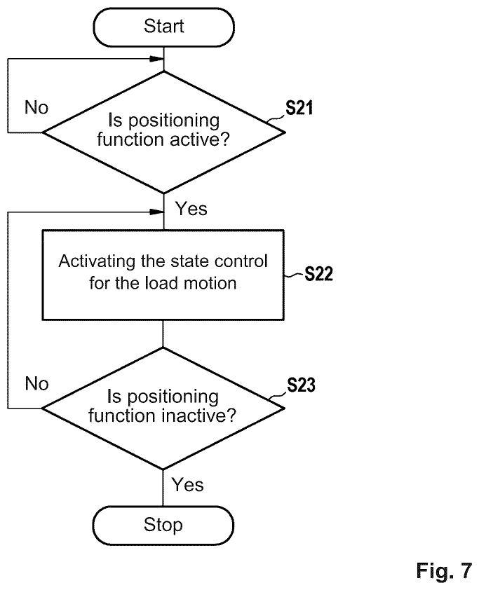

FIG. 7 illustrates a flowchart illustrating the positioning function.

In step S21, it is checked whether the positioning function is activated when the crane operation is inactive. If this is the case (alternative: Yes), the process continues with step S22. Otherwise (alternative: No), the process continues with S21.

In step S22, the state controller is activated, but the target specifications for the positions x, θ and the velocity x′, θ′, the trolley LK and the slewing gear DW are not taken into account, wherein the target specifications are assumed as follows:

$${x}_{xsoll}^{} = unbestimmt$$

$${x}_{soll}^{′} = unbestimmt$$

$${φ}_{xsoll} = 0$$

$${φ}_{xsoll}^{′} = 0$$

$${θ}_{soll} = unbestimmt$$

$${θ}_{soll}^{′} = unbestimmt$$

$${φ}_{ysoll} = 0$$

$${φ}_{xsoll}^{′} = 0$$

The state variables xₛₒₗₗ, x′ₛₒₗₗ, θₛₒₗₗ, θ′ₛₒₗₗ marked as undefined are not taken into account in the control process, as the corresponding control deviation or the associated element (factor) of the control vector K are set to zero during the activated disturbance variable compensation function.

In step S23, it is checked whether the positioning function has ended. If this is the case (alternative: Yes), the process is ended, otherwise (alternative: No) the program returns to step S22 and the state control is continued.

The third operating element 940 must be permanently actuated during positioning to prevent uncontrolled motions of the load L. The pendulum angle φₓ, φ_{y}, which deviates from zero when the load L or the load-carrying device UF is pulled, forces the state control to make a compensating motion in the pulling direction, so that the load is moved in the corresponding direction according to the pull. As soon as the tensile force is removed, the trolley LK positions itself exactly above the load L and thus fixes the new load position.

Furthermore, a load lifting function which is permanently active or can be activated by means of a fourth operating element 950 can be implemented, which provides additional safety when lifting the load. If the trolley LK, i.e. the suspension point AUP of the hoist rope, is not exactly perpendicularly above the center of mass, lifting the load can cause an immediate pendulum oscillation that depends on the lateral offset of the suspension point AUP to the center of mass. In practice, this is almost always the case, as the crane operator is usually unable to position the load-carrying device UF exactly above the center of gravity of the load.

By using the state control described above, the suspension point AUP can be positioned exactly above the center of mass when tightening the load-carrying device UF before lifting the load L.

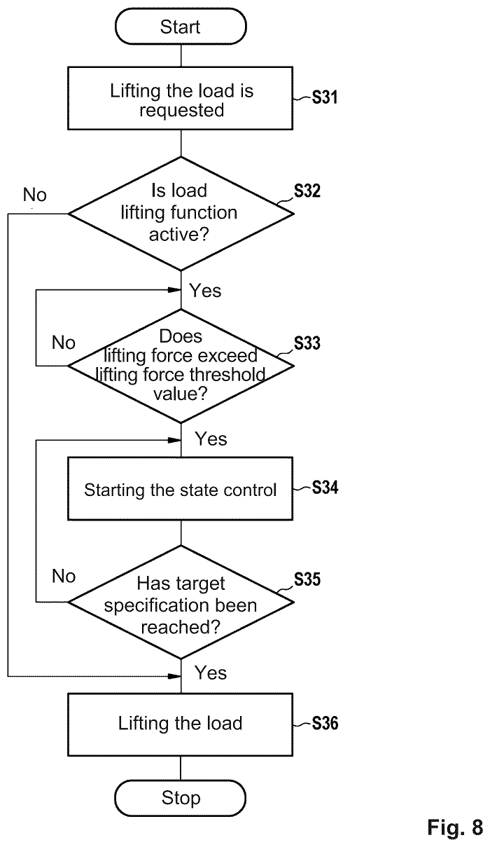

The load lifting function is explained in more detail with reference to the flowchart shown in FIG. 8.

In step S31, the hoisting gear HW is activated to lift the load according to the specification by the crane operator, e.g. using a fourth operating element 950.

In step S32, it is checked whether the load lifting function is activated. If this is the case (alternative: Yes), the process is continued with step S33. Otherwise (alternative: No), the process is ended by returning to step S36.

In step S33, the lifting force is monitored using the mass sensor device 620. If the lifting force exceeds a predetermined threshold lifting force value, which may be determined by the weight forces of the load-carrying device UF, the hoist rope HSL and the load rope LSL, it can be assumed that the hoist rope HSL is tensioned and the measured pendulum angle φₓ, φ_{y} indicates the offset of the center of mass to the suspension point AUP on the trolley LK. In this case (alternative: Yes), the process continues with step S34, otherwise (alternative: No) the process returns to step S33 and continues to wait for the threshold lifting force value to be reached.

Then, the state control is started in step S54 by specifying the target specifications:

$${x}_{soll}^{} = undefined$$

$${x}_{soll}^{′} = undefined$$

$${φ}_{xsoll} = 0$$

$${φ}_{xsoll}^{′} = 0$$

$${θ}_{soll} = undefined$$

$${θ}_{soll}^{′} = undefined$$

$${φ}_{ysoll} = 0$$

$${φ}_{ysoll}^{′} = 0$$

The state variables marked as undefined are not taken into account during the control process by setting the corresponding control deviation or the associated element (factor) of the control vector K to zero during the activated disturbance variable compensation function.

In step S35, it is checked whether the target specification for the pendulum angle φₓₛₒₗₗ=0, φ_{ysoll}=0 and the pendulum angular velocity φ′ₓₛₒₗₗ=0, φ′_{ysoll}=0 has been reached, i.e. all corresponding control deviations are below a specified threshold value of, for example, less than 0.3° of the corresponding pendulum angle. In general, this threshold value can be a function of the hoist rope length, e.g. 0.1°, e.g. for hoist rope lengths of more than 20 m, and 0.2° to 0.3° for hoist rope lengths l₁ of less than 20 m. If this is the case (alternative: Yes), the process is continued with step S36. Otherwise, the state control of step S34 is further continued.

Before the lifting force is further increased beyond the point of actual load lifting, the state control is thus further performed. This enables a precise positioning of the trolley LK above the load's center of gravity so that the load can be lifted without initial pendulum oscillation, i.e. perpendicular.

The load is then lifted in step S36.

Furthermore, a position approach function can be implemented by means of a fifth operating element 960. The position approach function ensures that when a stored position is approached, the stored position is approached and the load L is stopped there without pendulum oscillation. Only after stopping at the stored position, the position approach function is deactivated again, and the load can be moved in any direction in accordance with the crane operator's operation.

In step S41, it is checked whether a position approach function has been activated. If this is the case (alternative: Yes), e.g. when the fifth operating element 960 is operated, a current absolute position

$${p}_{x} = x + sin ( {φ}_{x} ) \cdot l , {p}_{y} = θ + arctan \frac{sin ( {φ}_{y} ) \cdot l}{x}$$

of the load L or the trolley LK (i.e. the suspension point AUP) x, e can be stored in step S42 (e.g. as xₛₜₒᵣₑ, θₛₜₒᵣₑ).

If an absolute load position is stored in accordance with the position approach function, then the crane is operable in a conventional manner in step S43.

In step S44, it is checked whether the current absolute position of the load L or the position of the suspension point AUP is approaching the stored position, which is determined by a continuously performed query. If this is determined (alternative: Yes), the stored position xₛₒₗₗ=pₓ, θₛₒₗₗ=p_{y} is assumed as the target position for the load in step S45, and the state control is performed accordingly. In this case, the further operation of the crane operator (or an automated crane control system) is irrelevant for the further target specification. After determining the approach to the stored position, only the positions x, θ are specified as the target specification so that the state controller performs a pure position control. The target specifications then correspond to:

$${x}_{soll} = {p}_{x} ;$$

$${x}_{soll}^{′} = 0$$

$${φ}_{xsoll} = 0$$

$${φ}_{xsoll}^{′} = 0$$

$${θ}_{soll} = {p}_{y} ;$$

$${θ}_{soll}^{′} = 0$$

$${φ}_{ysoll} = 0$$

$${φ}_{ysoll}^{′} = 0$$

The state variables marked as undefined are not taken into account in the control process by setting the corresponding control deviation or the associated element (factor) of the control vector K to zero during the activated position approach function.

If it is determined in step S46 that the stored position has been reached (alternatively: Yes), the state control is ended in step S47 for the time being. Otherwise (alternatively: No), the process is continued with step S45.

If the position that has been approached is left again by activating of the crane operation, the position approach function is reactivated and the process continues with step S43.

It may be provided that the stored load position is forgotten when the fifth operating element 960 is operated again.

1. A method, in particular a computer-implemented method, for operating a slewing jib crane by means of a state control, wherein the state control effects a control of a motion of a suspended load at least in one direction of motion and is based on a state vector, comprising the following steps:
detecting state variables of the state vector, which contain information on a position (x, θ) and a velocity (x′, θ′) of a movable suspension point, to which a load system comprising a hoist rope, a load-carrying device arranged at a lower end of the hoist rope and, if appropriate, a load suspended below the load-carrying device is suspended, and contains information on a load position (φₓ, φ_{y}) and a load velocity (φ′ₓ, φ′_{y}) of a center of mass of the load system with respect to the suspension point with respect to the at least one direction of motion,
determining at least one actuating variable (u*_{LK}, u*_{DW}, u*_{HW}) for moving the suspension point in the at least one direction of motion based on the state control;
operating the slewing jib crane as a function of the at least one actuating variable (u*_{LK}, u*_{DW}, u*_{HW}).

2. The method according to claim 1, wherein the state control is implemented in that, when there is a change in a state of the crane, in particular when there is a change in the length of the hoist rope (l₁) and/or a radial position of the suspension point, and in particular as a function of a mass of the load system, a parameterization of a state space description in the state space is updated and a linear combination of the control deviations of the state variables indicated by a control vector (Kx, Ky) is determined by a method of pole specification or the LQ method, which is used to calculate the at least one actuating variable (u*_{LK}, u*_{DW}, u*_{HW}) for moving the suspension point.

3. The method according to claim 1, wherein the at least one actuating variable (u*_{LK}, u*_{DW}, u*_{HW}) comprises an adjustment velocity of a trolley travel unit of a tower crane or an adjustment velocity of a luffing angle of a jib of a mobile crane and/or an adjustment velocity of a slewing gear.

4. The method according to claim 1, wherein the load position (φₓ, φ_{y}) as the relative position of the center of mass of the load system with respect to the suspension point is indicated as a function of a hoist rope angle, which indicates an angular deviation of the hoist rope attached to the suspension point to the perpendicular through the suspension point, and of a load rope angle, which indicates an angular deviation of a center of mass of the load at a suspension point on the load-carrying device to the perpendicular, wherein the load position (φₓ, φ_{y}) is further determined in particular as a function of a hoist rope length (l₁) between the suspension point and a center of mass of the load-carrying device, and/or a load rope length (l₂) between the suspension point and the center of mass of the load, wherein in particular the load position (φₓ, φ_{y}) is indicated as a pendulum angle (φₓ, φ_{y}) of the center of mass with respect to the perpendicular through the suspension point or as a vertical distance of the center of mass to the perpendicular through the suspension point.

5. The method according to claim 1, wherein the state control is operated to implement a pendulum damping function, in particular when the manual or automated crane operation specifies a velocity of the suspension point for at least one of the directions of motion, or a first operating element is operated for activating the pendulum damping function, wherein for pendulum damping a target specification of the information on the load position (φₓ, φ_{y}) and the load velocity (φ′ₓ, φ′_{y}) of the center of mass of the load system is specified as zero in each case, the target specification for the velocity (x′) of the suspension point is specified as zero, and the target specification for a position of the suspension point is specified as a position as a function of the specified velocity of the suspension point.

6. The method according to claim 5, wherein the pendulum oscillation damping remains active for a predetermined follow-up time when all target variables are set to zero.

7. The method according to claim 1, wherein the state control is operated or is operable in order to implement a disturbance variable compensation function, wherein the state control is continuously provided with a target specification for the position of the suspension point, which is determined as a function of a stored absolute position of the load, and a target specification of the velocity of the suspension point of zero, and the load position (φₓ, φ_{y}) and the load velocity (φ′ₓ, φ′_{y}) of the center of mass of the load system are not taken into account, in particular by setting the corresponding control deviations of the load position (φₓ, φ_{y}) and the load velocity (φ′ₓ, φ′_{y}) of the center of mass of the load system to zero during the activated disturbance variable compensation function, wherein in particular the target specification of the specification of the position of the suspension point is determined based on the current load position (φₓ, φ_{y}) of the center of mass, a pendulum length (l) of the load system and the current position of the suspension point.

8. The method according to claim 7, wherein the disturbance variable compensation function can be activated and deactivated by means of a second operating element, and is deactivated in particular during active crane operation for load transport, wherein the absolute position of the load is stored in particular when the disturbance variable compensation function is activated.

9. The method according to claim 1, wherein the state control is operated or is operable to perform a positioning function, wherein the state control is provided with the specification of the load position (φₓ, φ_{y}) and the load velocity (φ′ₓ, φ′_{y}) of the center of mass of the load system of zero as target specifications, and the position (x, θ) and the velocity (x′, θ′) of the suspension point are not taken into account, in particular by setting the corresponding control deviations during the activated positioning function or the associated element of the control vector K to zero.

10. The method according to claim 1, wherein the state control is operated or is operable to implement a load lifting function when a load is to be lifted, wherein the specification of the load position (φₓ, φ_{y}) is determined when a lifting force on the hoist rope exceeds a predetermined lifting force threshold value and the load has not yet been lifted, wherein the state control is performed with target specifications for the load position (φₓ, φ_{y}) and the load velocity (φ′ₓ, φ′_{y}) and the velocity (x′, θ′) of the suspension point of zero, wherein the control deviation with respect to the position (x, θ) of the suspension point is not taken into account, in particular by setting the corresponding control deviations or the associated element of a/the control vector K to zero during the activated load lifting function.

11. The method according to claim 1, wherein the state control is operated or is operable to implement a position approach function, in which a stored position is approached and the load is brought to a standstill there, wherein a current position is stored in accordance with a user request, wherein the state control is performed with a target specification for the position (x, θ) of the suspension point corresponding to the stored position, a target specification for the velocity (x′, θ′) of the suspension point of zero, a target specification for the load position (φₓ, φ_{y}) and the load velocity (φ′ₓ, φ′_{y}) of zero is performed as soon as the position of the suspension point has approached the stored position of the suspension point during ongoing crane operation, in particular below a predefined threshold distance.

12. A device, in particular a control unit, for operating a slewing jib crane by means of a state control, wherein the state control effects a control of a motion of a suspended load at least in one direction of motion and is based on a state vector, wherein the device is configured for:
detecting state variables of the state vector, which contains information on a position and a velocity (x′, θ′) of a movable suspension point, to which a load system comprising a hoist rope, a load-carrying device arranged at a lower end of the hoist rope and a load suspended below the load-carrying device is suspended, and information on a load position (φₓ, φ_{y}) and a load velocity (φ′ₓ, φ′_{y}) of a center of mass of the load system with respect to the suspension point,
determining at least one actuating variable (u*_{LK}, u*_{DW}, u*_{HW}) for moving the suspension point in the at least one direction of motion based on the state control; and
controlling the slewing jib crane as a function of the at least one actuating variable (u*_{LK}, u*_{DW}, u*_{HW}).

13. A slewing jib crane comprising:
one or more drive devices for moving a suspension point for a load system; and
the device according to claim 12, wherein the slewing jib crane is controlled by controlling the one or more drive devices.

14. A computer program product comprising instructions which, when the program is executed by at least one data processing device, cause it to perform the steps of the method according to claim 1.

15. A machine-readable storage medium comprising instructions which, when executed by at least one data processing device, cause it to perform the steps of the method according to claim 1.
